(19) United States
(12) Patent Application Publication
(10) Pub. No.: US 2016/0096127 A1
(43) Pub. Date: Apr. 7, 2016

(54) Filtration Article with Heat-Treated and Shrunken Fluoropolymer Knit

(71) Applicant: W. L. Gore & Associates, Inc., Newark, DE (US)

(72) Inventor: Bradley Marshall McClary, Elkton, MD (US)

(21) Appl. No.: 14/507,925

(22) Filed: Oct. 7, 2014

(51) Int. Cl. B01D 39/08

(52) U.S. Cl. CPC B01D 39/083

(57) ABSTRACT

A filtration article and method for filtering particles from a fluid stream, comprising: a first layer, positionable across the fluid stream, comprising a porous PTFE membrane for filtering particles from the fluid stream; and a second layer, positionable across the fluid stream to provide for at least one of drainage of and support of the first layer; wherein the second layer has an aperture area of less than about 0.08 mm².

### BACKGROUND

Porous membranes are widely used in the filtration of particulate, ionic, microbial and other contaminants from fluids in pharmaceutical, microelectronics, chemical and food industries. In use, the membranes are formed into a device (e.g., pleated cartridges which may be housed within a capsule, hollow tubes, stack of flat disks, etc.) which is placed in the fluid stream to be filtered.

To meet chemical and temperature resistance requirements, most filtration devices used in semiconductor fabrication are constructed entirely of fluoropolymer materials. The trend towards narrower line widths in semiconductor manufacturing has placed an ever increasing burden on particulate contamination control in semiconductor fabrication. Such a trend has led to the introduction of fluoropolymer filtration membranes having rated pore sizes as low as 10 nm.

While such membranes provide superior particle filtration, there is a desire to extend the life cycle, or time-in-use, of the membranes, while maintaining the filtration efficiency thereof. In this regard, in typical filtration implementations, a support layer may be positioned downstream of a fluoropolymer filtration membrane to support the membrane against the pressure of fluid flow. In addition, the support layer or another downstream layer may provide drainage functionality (e.g., by acting as a spacing layer with downstream passageways therethrough to thereby facilitate fluid flow through the membrane). In that regard, an upstream drainage layer may also be utilized.

In such arrangements, known upstream and downstream layers are constructed of fluoropolymeric fiber materials (e.g., PTFE, PFA or PVDF) in the form of wovens, non-wovens or nets. Over extended periods, such woven, non-woven or net layers may exhibit movement of fibers in the layer structure to a degree that renders such layers unable to provide the desired support to the filtration membrane against applied fluid pressure. This may result in damage to the membrane microstructure, and degradation of filtration efficiency and drainage functionality, to the point that filter replacement is required. Filter replacement entails not only system downtime, but also results in added filter costs and utilization of maintenance personnel resources.

Fluid filtration articles constructed with the knit materials of the invention described in US Patent Publication US 2014/0021145 provide an article having extended time-in-use advantages, while providing satisfactory filtration (retention) efficiency over the extended life of the device. A fluid filtration article with still greater retention efficiency and strength is desired, however.

### SUMMARY

This disclosure describes a filtration article for filtering particles from a fluid stream, comprising: a first layer, positionable across the fluid stream, comprising a porous PTFE membrane for filtering particles from the fluid stream; and a second layer, positionable across the fluid stream to provide for at least one of drainage of and support of the first layer, comprising a plurality of strands of fluoropolymer fibers arranged to form a knit having a plurality of interlocking regions that are each defined by corresponding different sets of at least two interlocking loop portions of the plurality of strands of fluoropolymer fibers, wherein the plurality of interlocking regions of the knit define a plurality of wales and a plurality of courses, and wherein for at least a first portion of the plurality of strands each strand comprises different loop portions that partially define different, alternating ones of the plurality of interlocking regions located along at least two different ones of the plurality of wales; and wherein the second layer has an aperture area of less than about 0.08 mm².

Also provided is a method of filtering particles from a fluid stream comprising the steps of providing a plurality of strands of fluoropolymer fibers; arranging the strands to form a knit having a plurality of interlocking regions that are each defined by corresponding different sets of at least two interlocking loop portions of the plurality of strands of fluoropolymer fibers, wherein the plurality of interlocking regions of the knit define a plurality of wales and a plurality of courses, and wherein for at least a first portion of the plurality of strands each strand comprises different loop portions that partially define different, alternating ones of the plurality of interlocking regions located along at least two different ones of the plurality of wales; heating the knit while simultaneously shrinking the knit by at least 10% to provide an aperture area of less than about 0.08 mm²; providing a porous PTFE membrane; and disposing both the membrane and the knit in the fluid stream to filter the particles.

### BRIEF DESCRIPTION OF THE DRAWINGS

FIG. 1 illustrates an exemplary embodiment of a filtration article in an exemplary filtration device according to the present disclosure.

FIGS. 2A and 2B illustrate exemplary embodiments of a knit layer in an exemplary filtration article according to the present disclosure.

FIGS. 3A and 3B are images of exemplary embodiment of a knit layer in an exemplary filtration article according to the present disclosure.

FIGS. 4A and 4B illustrate exemplary embodiments of knit construction of another knit layer according to the present disclosure.

FIGS. 5a, 5b, 5c illustrate a microscopic image of a raw knit, a heat shrunk embodiment of the present disclosure, and a heat set knit, respectively.

### DETAILED DESCRIPTION OF THE INVENTION

Described herein are embodiments of fluid filtration articles comprising at least one layer of an improved fluoropolymer knit material. The knit layer may be used as a support and/or drainage layer in a filter cartridge that may be made wholly of fluoropolymer materials. Such knit layer(s) provide for filtration articles having improved particle retention efficiency.

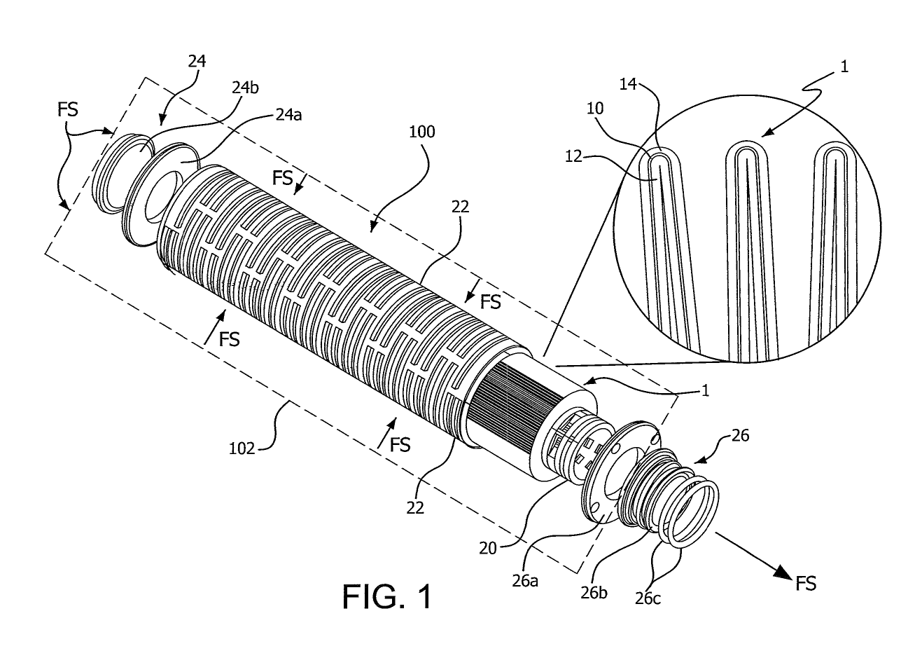

FIG. 1 is an illustration of a filter cartridge (100) that may be constructed wholly of fluoropolymer materials and that may be sized for positioning within a filtration capsule (102) (depicted by phantom lines in FIG. 1) through which a fluid stream (FS) passes. The filter cartridge (100) may include a filtration article (1) that comprises a pleated porous fluoropolymer filtration membrane (10), a pleated fluoropolymer knit layer (12) disposed on the downstream side of the filtration membrane (10), and an optional pleated fluoropolymer knit layer (14) disposed on the upstream side of the filtration membrane (10). As shown, the filtration membrane (10), knit layer (12) and knit layer (14) may be at least partially nested. One or both ends of the pleated filtration membrane (10), knit layer (12), and knit layer (14) of filtration article (1) may be potted to sealably interconnect such end(s).

The utilization of a pleated configuration in filtration articles provides for increased filtration capacity by increasing the operative size of filtration membrane (10). In the embodiment shown in FIG. 1, the pleated filtration article (1) is of a cylindrical, tubular configuration having outwardly-projecting pleats of an inverted V-shaped configuration that are positioned about and extend along a longitudinal axis from end-to-end of the filtration article (1). In this regard, the peats define V-shaped regions, or valleys, between adjacent ones of the pleats about and along the longitudinal axis of the article.

The filter cartridge (100) may also include an inner core (20), an outer cage (22), and end assemblies (24), (26). The end assembly (24) may include an annular member (24a) having an annular interface interconnected to outer cage (22) (e.g., via a surface-to-surface melt operation), and a closure member (24b) having an annular surface interconnected to annular member (24a) (e.g., via a surface-to-surface melt operation). The end assembly (26) may include an annular member (26a) having an annular surface interconnected to an annular surface of a flanged tubular interface member (26b), and seal members (26c) (e.g., O-Rings) disposed on the tubular interface member (26b), wherein the end assembly (26) may be sealably interconnected to an exit port from filtration capsule (102).

The fluoropolymer membrane (10) may comprise an expanded PTFE membrane which may be prepared according to the methods described in U.S. Pat. No. 7,306,729, U.S. Pat. No. 3,953,566, U.S. Pat. No. 5,476,589 and U.S. Pat. No. 5,183,545, hereby incorporated by reference in their entirety. The fluoropolymer membrane may also comprise an expanded polymeric material comprising a functional TFE copolymer material comprising a microstructure characterized by nodes interconnected by fibrils, wherein the functional TFE copolymer material comprises a functional copolymer of TFE and PSVE. The functional TFE copolymer material may be prepared according to the methods described in U.S. Patent Publication No. 2010/0248324, hereby incorporated by reference in its entirety.

The core (20), cage (22) and end assemblies (24), (26) may be comprised of known thermoplastic fluoropolymers such as PFA, FEP, ETFE, PCTFE, ECTFE, PVDF, etc.

As shown in FIG. 1, the filter cartridge (100) may be disposed so that the fluid stream (FS) flowing into filtration capsule (102) flows through openings in cage (22), through filtration article 1, and through openings of core (20) to a tubular passageway extending through and out of the filter cartridge (100) via end assembly (26). The upstream knit layer (14) acts as a spacer to provide passageways for fluid flow between and through the outwardly-facing surfaces of adjacent ones of the pleats of the filtration membrane (10). The downstream layer (12) acts as a spacer to provide passageways for fluid flow between and through the inwardly-facing surfaces of the filtration membrane (10). The downstream knit layer (12) is further disposed to provide support for the filtration membrane (10) against applied fluid pressure.

In the later regard, in the illustrated arrangement the downstream layer (12) may be disposed directly adjacent to filtration membrane (10) to provide surface-to-surface support of the filtration membrane (10) against the fluid pressure load applied by fluid stream FS. In other arrangements, the downstream layer (12) may provide support to filtration membrane (10) with one or more intermediate layers positioned therebetween.

As noted above and further described below, the downstream layer (12) may be of a knit construction that advantageously distributes the fluid pressure load across the downstream layer (12) via the provision of interlocking regions, thereby yielding enhanced stability and increased time-in-use attributes relative to prior fluid filtration articles. In certain arrangements such as the pleated configuration shown in FIG. 1, a knit construction of downstream layer (12) also defines passageways between and about the interlocking regions to facilitate fluid flow therethrough, i.e., membrane drainage functionality.

In various embodiments, filtration articles (e.g., filter article (1) referenced above) may include a filtration layer (e.g., filtration membrane (10) referenced above) and one or more knit layer(s) (e.g., downstream layer (12) and/or upstream layer (14) referenced above) that comprise strands of fluoropolymer fibers arranged to define a knit with interlocking regions having interlocking loops which reduce material stretch in at least one direction to yield a more dimensionally stable knit. Also, the interlocking loop configuration of the knit construction provides additional space to allow fluid flow patterns in and around interlacing fibers. This is advantageous compared to a woven construction having orthogonal fibers in which flow may be restricted to the woven's mesh openings only.

The fibers of the knit layer(s) may comprise fluoropolymers selected from PTFE, PVDF, FEP or PFA. Preferably, a PTFE fiber may be used to construct the knit layer. A PTFE knit layer is constructed from yarn having at least one PTFE fiber. The term PTFE is meant to also include expanded PTFE, expanded modified PTFE, and expanded copolymers of PTFE, as described in U.S. Pat. Nos. 5,708,044, 6,541,589, and 7,531,611, and U.S. patent application Ser. Nos. 11/906,877 and 12/410,050, all of which are hereby incorporated by reference in their entirety. The PTFE fiber comprises oriented fibrils and may be non-porous or porous. The PTFE fiber may be a monofilament or it may be two different PTFE fibers having differing deniers, density, length or dimensional differences. A multiple strand of yarn having at least one PTFE fiber and at least one other type of fluoropolymer fiber that is not PTFE may also be employable in filtration article embodiments.

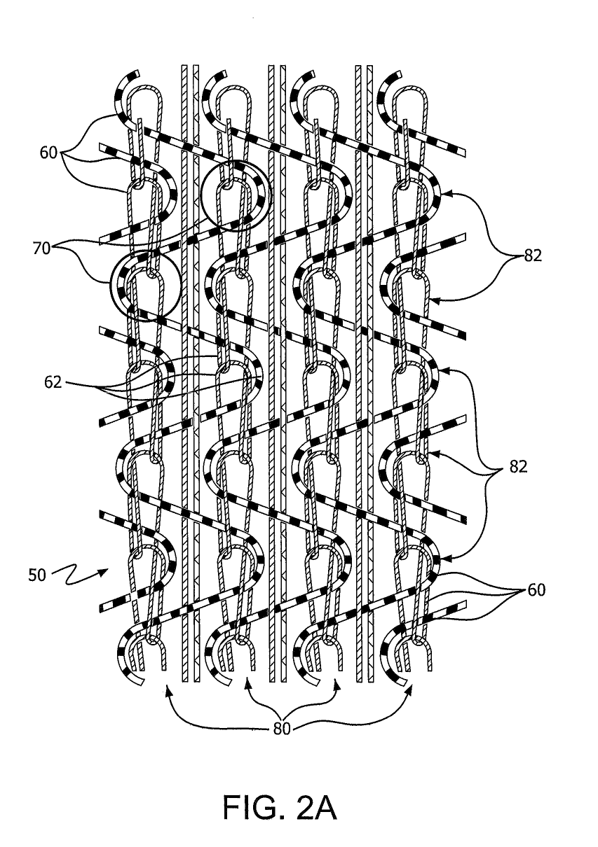

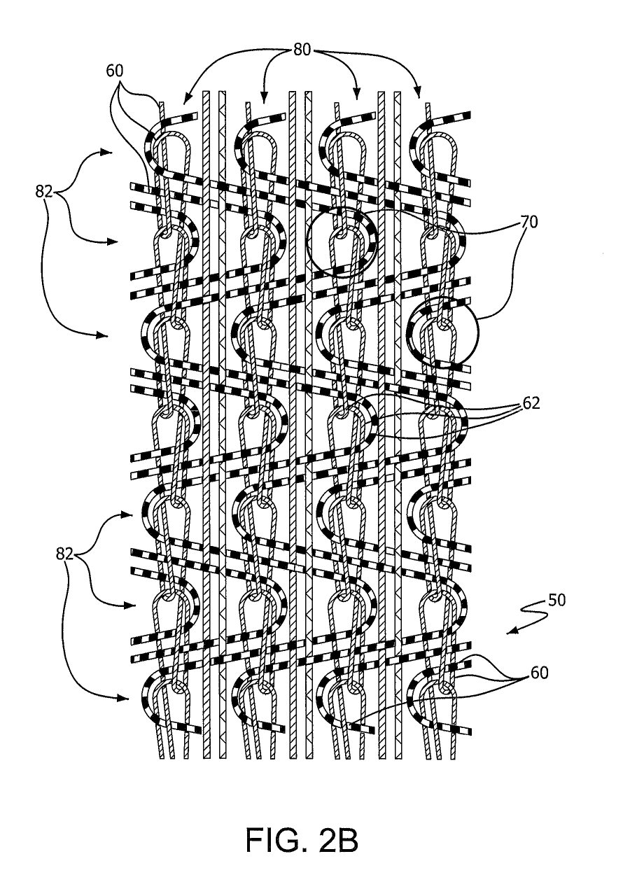

FIGS. 2A and 2B illustrate embodiments of the construction of a knit layer (50) of a filtration article embodiment. As will be understood, knit layer (50) may be positioned downstream and/or upstream of a filtration layer comprising a porous PTFE material (e.g., a PTFE membrane) for filtering particles from a fluid stream. In this regard, knit layer (50) may provide support and drainage functionality when located downstream of a filtration layer, and may provide drainage functionality when located upstream of a filtration layer.

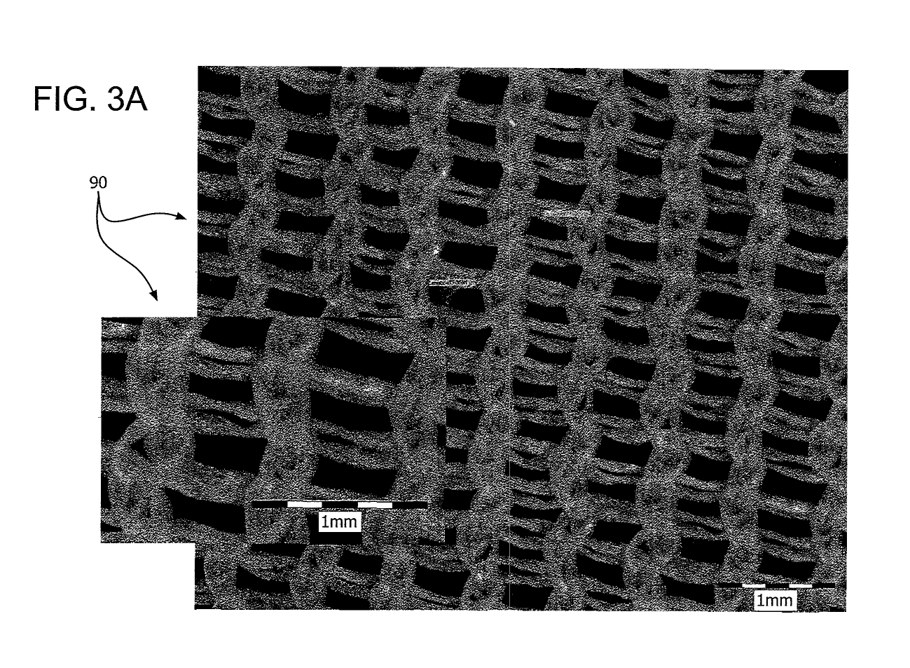

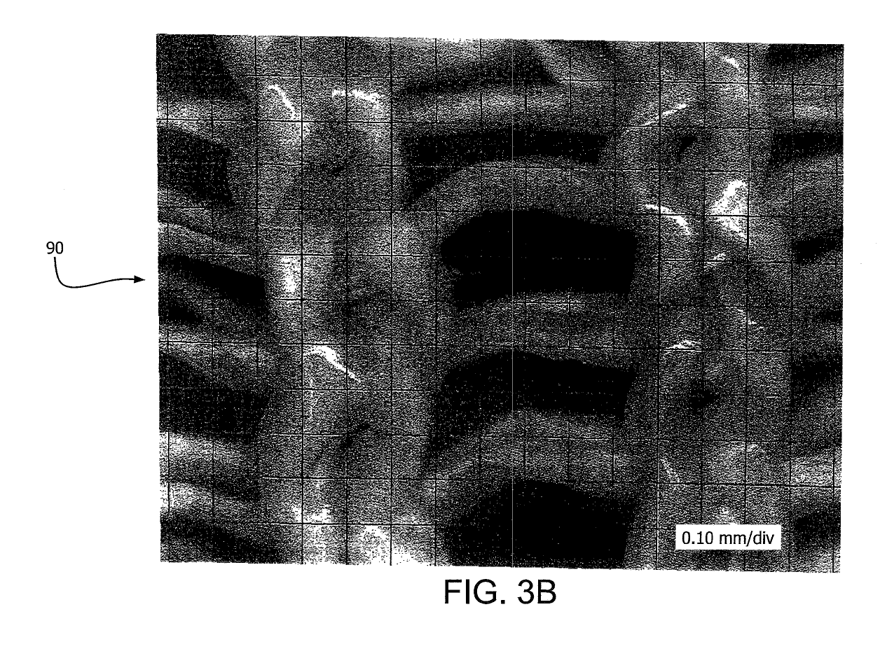

As shown in the embodiments of FIGS. 2A and 2B, knit layer (50) may comprise strands (60) of fluoropolymer fibers arranged to define a plurality of interlocking regions (70), two of which are encircled in each of FIGS. 2A and 2B. The knit layer (50) shown in FIGS. 2A and 2B illustrates the interlocking regions (70) in an untightened state for purposes of understanding, and it will be understood that the interlocking regions (70) are tightened prior to use (e.g., as shown in the embodiment of FIGS. 3A and 3B). As shown, each of the interlocking regions (70) are each defined by corresponding different sets of at least two interlocking loop portions (62) of the strands (60). The interlocking regions (70) may define a plurality of wales (80) and a plurality of courses (82).

The interlocking regions (70) may function to restrain relative movement and/or elongation of strands (60) between the interlocking regions (70) by distributing fluid pressure loads therebetween, thereby yielding enhanced stability. In this regard, in the embodiments shown in FIGS. 2A and 2B, the interlocking regions (70) are each defined by corresponding different sets of three interlocking loop portions (62) of the strands of fluoropolymer fibers (60). As shown, for a portion of the strands (60) each strand comprises different loop portions that partially define different, alternating ones of the plurality of interlocking regions (70) located along at least two different ones of said plurality of wales (80). Further, for another portion of strands (60) each strand comprises different loop portions that partially define different ones of all of the interlocking regions (70) located in a corresponding one of the wales (80). Such provision of interlocking regions (70) distributes a fluid pressure load applied to knit layer (50) by distributing the load at and across interlocking regions (70) located in different wales and courses.

For example, in the embodiment of FIG. 2A, for a portion of the strands (60), each strand comprises different loop portions that partially define different alternating ones of the plurality of interlocking regions (70) located along two adjacent ones of the wales (80), while in the embodiment of FIG. 2B, for a portion of the strands (60), each strand comprises different loop portions that partially define different alternating ones of the plurality of interlocking regions (70) located along two of the wales (80) having another one of the wales (80) located therebetween.

In various embodiments, the loop portions of strands (60) defining interlocking regions (70) may be disposed to extend about an arc of at least 90° along different corresponding arcuate paths. With reference to the embodiments of FIGS. 2A and 2B at least a portion of the loop portions of strands (60) corresponding with the interlocking regions (70) may be disposed to extend about an arc of at least 180° along different corresponding arcuate paths.

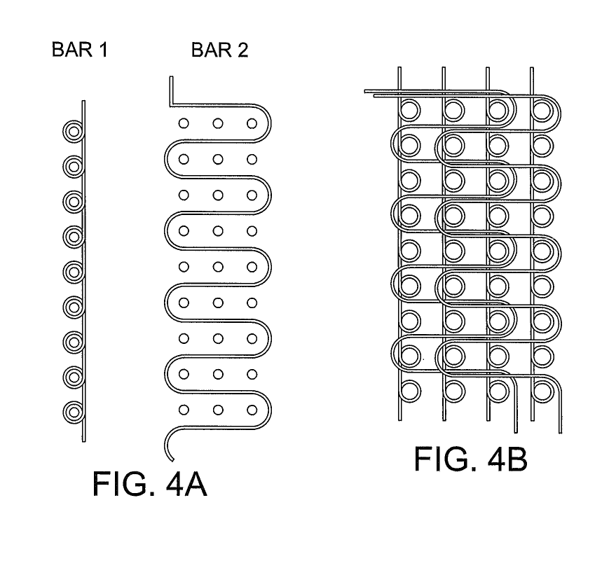

FIGS. 3A and 3B show images of an embodiment of a PTFE knit layer (90) of the present invention. The knit layer (90) is comprised of expanded PTFE (ePTFE) fiber and is constructed using a 2 bar in lay Raschel locked stitch design. The construction of such 2 bar in lay Raschel design is shown in FIGS. 4A and 4B. The knit layer (90) provides a dimensionally stable construction in the wale and warp directions.

The low coefficient of friction of PTFE poses a challenge in constructing a dimensionally stable knit. However, by using an interlock stitch design employing a 2 bar in lay interlock stitch, in the knit layers shown in FIGS. 2A, 2B, 3A and 3B, a dimensionally stable knit may be constructed.

While FIGS. 2A, 2B, 3A, 3B, 4A and 4B show specific knit design embodiments, it should be understood that any knit pattern yielding dimensional stability in the wale and/or course direction(s) such as a weft knit using an interlock stitch Tricot design may also be used.

The fluoropolymer knits described herein may be placed either upstream or downstream of a filtration membrane. Knit layers may also be placed on both upstream and downstream of the filtration membrane. The knit layers may be provided in a variety of configurations (e.g., planar, planar with pleats, tubular, tubular with pleats, etc.). In one arrangement, knit layers may be positioned on opposing sides of a filtration membrane and the layers may be pleated and sealed on the ends to form a pleated filtration cartridge, as contemplated above, using known methods described in the art. Further, the cartridge may further be placed in a capsule or housing through which a fluid stream passes.

In various embodiments an intermediate layer may be disposed between the filtration membrane and the knit layer. The intermediate layer may provide additional support. Suitable intermediate layers include porous fluoropolymer nets, wovens, membranes or non wovens. A preferred intermediate layer may be a porous fluoropolymer article described in U.S. Patent Publication No. 2012/064273.

The applicant has further discovered a method that produces a novel and inventive knit layer for use in a filtration article. The method is heat-treating the above-described knit layer while simultaneously shrinking it. This produces a heat-treated and shrunken knit layer that has the surprising result of providing twice the retention efficiency, under certain conditions, of a knit layer that has not been heat-treated and shrunk as disclosed herein. In addition, the heat-treated and shrunken knit layer is stronger and thus more durable than other known knits for filtration article applications. The aperture size of the knit layer decreases as a result of the disclosed method, yet the knit layer functions suitably in a filtration article, allowing adequate throughput. Another surprising result of using the disclosed method to produce the novel knit layer is that final device cleaning for particle count reduction is found significantly better. That is, the knit treated according to the disclosed method shows reduced particulation.

The knit layer is preferably heated to a temperature of between 350 and 380 degrees C. for a time of at least 5 seconds (and up to five minutes). The knit layer is shrunk simultaneously during heating between 10% and 60%, preferably 30% and 50%, and most preferably about 40%. The shrinkage is also affected by the denier of the knit, with smaller deniers requiring greater shrinkage.

The following examples and comparative examples further illustrate and describe this disclosure, along with associated beneficial properties and surprising results achieved therewith. For example, only 50-denier knit is illustrated, but greater or lower deniers are contemplated. Nevertheless, the examples as well as the foregoing description are not intended to limit the invention to the form disclosed herein. Consequently, variations and modifications commensurate with the teachings herein, and skill and knowledge of the relevant art, are within the scope of the present invention. The embodiments described herein are intended to explain known modes of practicing the invention and to enable others skilled in the art to utilize the invention in such or other embodiments and with various modifications required by particular applications or uses. It is intended that the appended claims be construed to include alternative embodiments to the extent permitted by the prior art.

### Test Methods and Measurements

### Stiffness

The overall Hand, or average textile stiffness, of the knits were measured according to the INDA Standard Test 1ST 90.3 (95) Handle-O-Meter Stiffness of Nonwoven Fabrics.

### Strength

This test was based on ASTM D3787 which is typically used to measure the burst strength of materials such as fabrics (woven, knit, nonwoven, etc.), porous or nonporous plastic films, membranes, sheets, etc., laminates thereof, and other materials in planar form. A specimen was mounted taut, but unstretched, between two annular clamping plates with an opening of 44.45 mm in diameter. A metal rod having a polished steel 25.4 mm diameter ball-shaped tip applied a load against the center of the specimen in the Z-direction (normal to the X-Y planar directions). The rod was connected at its other end to an appropriate force gauge. The load was applied at the rate of 13 mm/minute until failure of the specimen occurred. The failure (tearing, burst, etc.) may occur anywhere within the clamped area. Results were reported as the average of three measurements of the maximum applied force before failure.

### Aperture Area

The aperture size was measured using a microscope (Model VHX600E, Keyence Corporation) under a magnification range from 30× to 100×. A knit sample was placed under the microscope. Three apertures were selected at random, and the aperture area was reported directly by the software in the microscope in mm².

### Thickness

The thickness of the knit samples were measured using a caliper gauge (Model 547, Mitutoyo Corporation)

### Aperture Volume

The aperture volume, in mm³ was calculated as the product of the aperture area and thickness.

Retention Test Method after Exposure to Hot Air Flow

A knit layer was placed on a sample holder (Meissner 47 mm Filter Holder). An ePTFE membrane layer (Gore SMO89002) was placed on top of the knit sample. The sample holder was clamped, the sample consisting of the above two layers was subjected to air flow (200 degrees Celcius, 10 psig) for 60 minutes such that the ePTFE membrane layer was the side facing air flow.

The sample was then wet with IPA and subjected to an initial rinse using 250 mL of a solution containing 0.1% Triton X-100 in DI water. This rinse was done at about 3 psid differential pressure across the test sample. The effluent was collected and labeled as “background.”

The challenge solution was prepared using 49 nm microspheres (Part No. B50, Thermo Fisher Scientific Inc.). The 49 nm challenge solution was prepared by adding 83 micro liter of a 1% by weight stock solution containing the 49 nm microspheres to 2 liters of a solution containing 0.1% Triton X-100 in DI water.

Then, under a differential pressure of 6 psid across the sample, 250 mL of challenge solution was allowed to flow through the sample. The filtrate was collected and labeled as “downstream.”

Cary Eclipse fluorescent spectrophotometer was used to measure the fluorescence intensity of challenge solution, background and the downstream sample. The intensity measurements from the spectrophotometer were calibrated against a 3 point curve with calibration standards generated from a challenge solution of three different particle concentrations of a given microsphere size. From the intensity values, the particle retention efficiency (E) in % was calculated according to the following equation

$$E = 100 \% * [ 1 - ( \frac{downstream - background}{challenge - background} ) ]$$

### EXAMPLES

### Comparative Example 1

### 50 Denier: Untreated (Raw)

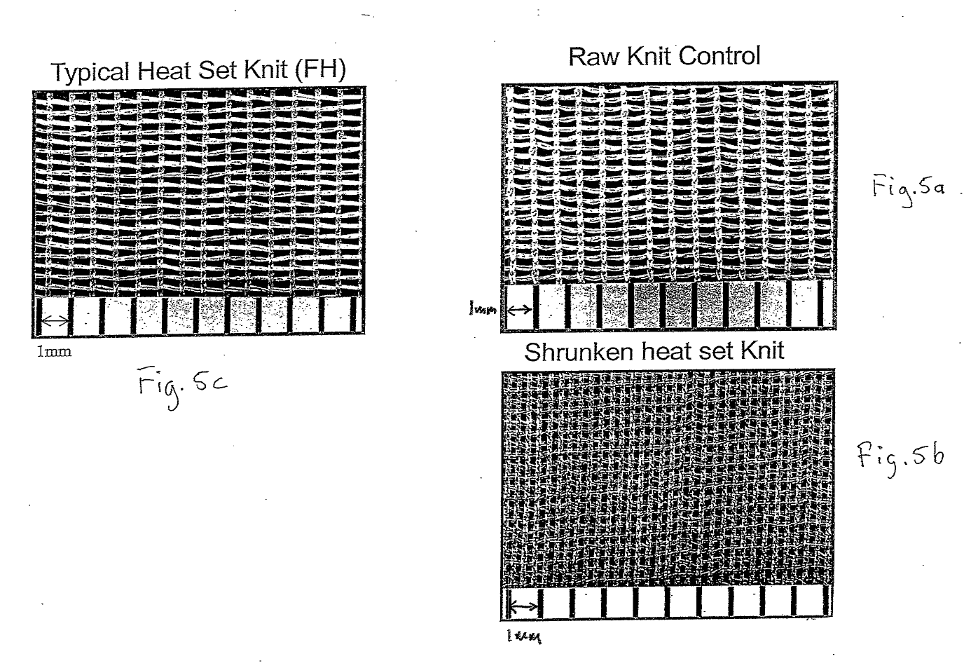

A knit sample was made from expanded PTFE fiber with the characteristics described in Table I. A warp beam composed of 400 ends of the ePTFE fiber was created where tension over the width of the beam was held constant resulting in a warp beam with minimal wrinkles and fiber crossovers. The warp beam was placed on a typical 2-bar warp knitting machine. Additional supply cones of the ePTFE fiber were used for the insertion fiber. The desired knit was produced using a 2-bar in lay Raschel locked stitch design. Table II describes some of the characteristics of this knit sample referred to as the “untreated” or “raw” knit. FIG. 5a is a microscopic image of the raw knit taken at a magnification of 30×.

### Example 1

### Heat-Treated and Shrunk

The raw knit, thus produced at a width of about 24 inches was unwound from a mandrel supporting its core. The raw knit sample was supported using a traveling pin frame with the pins taped in to from about 24 inches to about 13 inches apart and passed through a convection oven set at 365 degrees Celcius at a rate of 20 feet per minute. This pin spacing allowed the knit to shrink transversely to about 40% while undergoing heat treatment. After being simultaneously subjected to shrinking and heat treatment in the tenter oven, the knit sample was collected on another rotating core. The heat shrunk knit characteristics are reported in Table II. FIG. 5b is a microscopic image of the heat shrunk set knit taken at a magnification of 30×.

As described in Table II, the heat shrunk knit showed significant improvements in strength and stiffness compared to the raw knit. The aperture size and volume were reduced as a result of simultaneous shrinking while undergoing heat treatment. Further, it was surprising to note the improvement in particle retention efficiency of the shrunken knit by almost a factor of two.

TABLE I

| | |
|---|---|
| Filament Type | Monofilament |
| PTFE Fiber Description | 50 Denier ePTFE flat fiber (Part Number |
| | 020175601, available from W. L. Gore & |
| | Associates, Inc) twisted at 32 Twists Per Inch |
| | (TPI), Z - configuration using a Ring Twister |
| PTFE Fiber Diameter | 55 micron |
| Knit Pattern | 2 bar in lay Raschel locked stitch |
| | Front Bar 0/1, 0/1 |
| | Back Bar 0/0, 0/3 |
| Knit Gauge | 32 |
| Wales Per Inch (WPI) | 32 relaxed |
| Courses Per Inch (CPI) | 75.5 relaxed |
| Knit Style: | SR6031 or SR6031-2B |
| | 2B indicates 2 panels wide |
| Knit Quality: | 6.36 inch per rack |
| | (at a machine course count of 75.5 per inch) |
| Knit Width at Gauge | 24 inches |

TABLE II

| | Raw Knit | | |
|---|---|---|---|
| | (Comparative | | Comparative |
| | Example 1) | Example 1 | Example 2 |
| Thickness (mm) | 0.18 | 0.17 | 0.165 |
| Aperture Size | 0.088 | 0.0398 | 0.103 |
| Aperture Volume | 0.016 | 0.007 | 0.017 |
| Open Area % | 38 | 27 | 40 |
| Stiffness, g | 3 | 45 | 17 |
| Knit Basis Weight (g/m²) | 77 | 128 | 78 |
| Strength - Ball Burst, N | 277 | 452 | 327 |
| Particle Retention | 13 | 24 | 17 |
| Efficiency after | | | |
| exposure to hot air flow | | | |

### Comparative Example 2

### Heat Set Only

The raw knit produced according to Example 1 at a width of about 24 inches was unwound from a mandrel supporting its core. The raw knit sample was supported using a traveling pin frame with the pins spaced about 22.5 inches apart and passed through a convection oven set at 365 degrees Celcius at a rate of 20 feet per minute. This pin spacing did not allow for any substantial shrinkage of the knit while being subjected to heat treatment. After heat treatment in the tenter oven, the knit sample was collected on another rotating core. The characteristics of the heat set knit thus produced are reported in Table II. FIG. 5c is a microscopic image of the heat set knit taken at a magnification of 30×.

What is claimed is:

1. A filtration article for filtering particles from a fluid stream, comprising:
a first layer, positionable across said fluid stream, comprising a porous PTFE membrane for filtering particles from said fluid stream; and
a second layer, positionable across said fluid stream to provide for at least one of drainage of and support of said first layer, comprising a plurality of strands of fluoropolymer fibers arranged to form a knit having a plurality of interlocking regions that are each defined by corresponding different sets of at least two interlocking loop portions of said plurality of strands of fluoropolymer fibers, wherein said plurality of interlocking regions of the knit define a plurality of wales and a plurality of courses, and wherein for at least a first portion of said plurality of strands each strand comprises different loop portions that partially define different, alternating ones of said plurality of interlocking regions located along at least two different ones of said plurality of wales;
wherein said second layer has an aperture area of less than about 0.08 mm².

2. A filtration article as defined in claim 1 wherein said second layer has an aperture volume of less than about 0.015 mm³.

3. A filtration article as defined in claim 1 wherein said second layer an aperture area of less than about 0.06 mm².

4. A filtration article as defined in claim 1 wherein said second layer an aperture area of about 0.04 mm².

5. A filtration article as defined in claim 1 wherein said second layer has an aperture volume of less than about 0.010 mm³.

6. A filtration article as defined in claim 1 wherein said second layer has an aperture volume of about 0.007 mm³.

7. A method of filtering particles from a fluid stream comprising the steps of
(a) providing a plurality of strands of fluoropolymer fibers;
(b) arranging said strands to form a knit having a plurality of interlocking regions that are each defined by corresponding different sets of at least two interlocking loop portions of said plurality of strands of fluoropolymer fibers, wherein said plurality of interlocking regions of the knit define a plurality of wales and a plurality of courses, and wherein for at least a first portion of said plurality of strands each strand comprises different loop portions that partially define different, alternating ones of said plurality of interlocking regions located along at least two different ones of said plurality of wales;
(c) heating said knit while simultaneously shrinking said knit by at least 10% to provide an aperture area of less than about 0.08 mm²;
(d) providing a porous PTFE membrane; and
(e) disposing both said membrane and said knit in said fluid stream to filter said particles.

8. A method as defined in claim 7 wherein said step heating is at a temperature of about 350 to 380 degrees C.

9. A method as defined in claim 7 wherein said shrinking is by about 30-50%.

10. A method as defined in claim 7 wherein said shrinking is by about 40%.

11. A method as defined in claim 7 wherein said step (c) provides an aperture area of less than about 0.04 mm².

12. A method as defined in claim 7 wherein said step (c) provides an aperture volume of less than about 0.015 mm³.

13. A method as defined in claim 7 wherein said step (c) provides an aperture volume of about 0.007 mm³.
